(19) United States
(12) Patent Application Publication
(10) Pub. No.: US 2013/0250469 A1
(43) Pub. Date: Sep. 26, 2013

(54) USE OF FUSES TO CONNECT PARALLEL COLUMNS OF METAL OXIDE VARISTORS

(71) Applicant: Bruce Edward English, Saratoga Springs, NY (US)

(72) Inventor: Bruce Edward English, Saratoga Springs, NY (US)

(73) Assignee: GENERAL ELECTRIC COMPANY, Schenectady, NY (US)

(21) Appl. No.: 13/428,145

(22) Filed: Mar. 23, 2012

(51) Int. Cl. H02H 3/02

(52) U.S. Cl. 361/104

(57) ABSTRACT

A system is disclosed including a plurality of metal oxide varistors (MOVs) columns connected in parallel, and at least one fuse connected to an MOV column. The fuse(s) are configured to isolate the MOV column in the case that the fuse is activated.

### BACKGROUND OF THE INVENTION

The subject matter disclosed herein relates generally to surge protection for power systems. More particularly, the subject matter disclosed herein relates to the use of fuses to connect multiple, parallel, columns of metal oxide varistors.

Multiple parallel columns of metal oxide varistors (MOVs) are typically used as overvoltage protection of devices that use a high amount of energy but still need surge protection, for example, capacitors. Because the columns do not share current equally, connection of multiple parallel columns of MOVs requires some method of controlling the sharing of current between columns. Conventionally this is accomplished through current-share testing at a factory. For example, using voltage impulses on one or more MOV's, then measuring and comparing currents through each column tested, then reconfiguring and swapping columns, then testing again. This process can be lengthy and costly.

When MOVs fail, they typically fail as a short-circuit, as a low-impedance arc. Depending on the application, short-circuit currents flowing through this failed MOV will dissipate energy in the form of increasing pressure (which can lead to explosions) and/or heat radiated from a high-power arc that is difficult to control. Conventionally this is mitigated by pressure-relief and arc-control devices built-into the units, and these devices must be tested in high-current power laboratories using costly and cumbersome testing methods.

### BRIEF DESCRIPTION OF THE INVENTION

A system including fuses connected to multiple, parallel, columns of metal oxide varistors (MOV) is disclosed. In one embodiment, the system includes a plurality of MOV columns connected in parallel, and at least one fuse connected to one or more MOV columns. The fuse(s) are configured to isolate the MOV column in the case that the fuse is activated.

A first aspect of the invention includes a system comprising: a plurality of metal oxide varistors (MOVs) columns connected in parallel; and at least one fuse connected to at least one MOV column, the at least one fuse configured to isolate the MOV column in the case that the at least one fuse is activated.

A second aspect of the invention includes a system comprising: a plurality of metal oxide varistors (MOVs) columns connected in parallel; at least one fuse connected to at least one MOV column, the at least one fuse configured to isolate the MOV column in the case that the at least one fuse is activated; and at least one capacitor connected in parallel with the plurality of MOV columns.

### BRIEF DESCRIPTION OF THE DRAWINGS

These and other features of this invention will be more readily understood from the following detailed description of the various aspects of the invention taken in conjunction with the accompanying drawings that depict various embodiments of the invention:

FIG. 1 shows a system using fuses to connect multiple parallel columns of MOVs according to an embodiment of the invention;

FIG. 2 shows a system using fuses to connect multiple columns of MOVs in parallel and series, according to an embodiment of the invention;

FIG. 3 shows a system using fuses to connect multiple parallel columns of MOVs according to another embodiment of the invention; and

FIG. 4 shows a system using fuses to connect multiple parallel columns of MOVs and a plurality of fused capacitors according to an embodiment of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

The subject matter disclosed herein relates generally to a surge protection system for a power system. More particularly, the subject matter disclosed herein relates to the use of current-limiting fuses to connect multiple, parallel, columns of metal oxide varistors (MOVs).

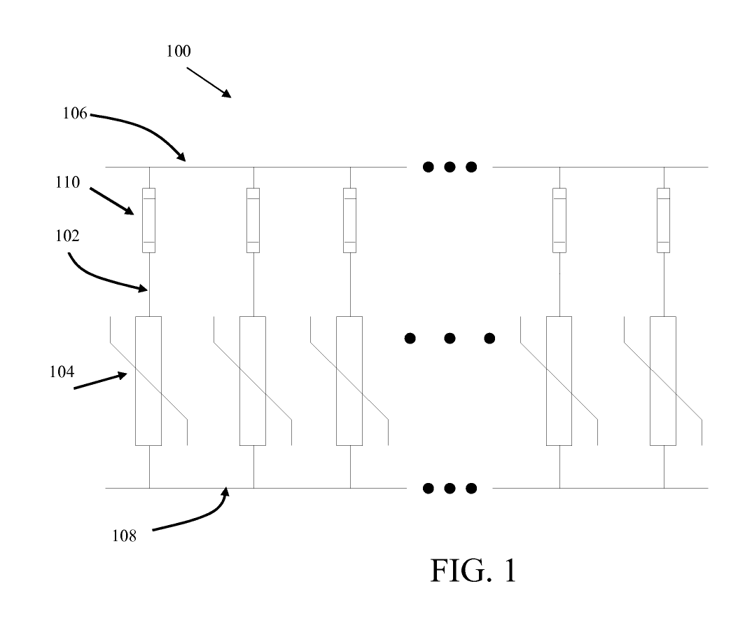

Turning to FIG. 1, a system 100 is shown according to an embodiment of the invention. System 100 includes a plurality of metal oxide varistors (MOVs) columns 102 connected in parallel. As shown in FIG. 1, each MOV column 102 includes at least one MOV 104. MOV 104 can comprise any known or later developed varistor as known in the art, configured to protect circuits against excessive transient voltages. As known in the art, each MOV 104 has a “reference voltage” that once the voltage across MOV column 102 reaches or exceeds that reference voltage, MOV 104 will begin to conduct current to limit the voltage across the MOV to some maximum value (sometimes referred to as its “protective level voltage”) according to its material characteristics.

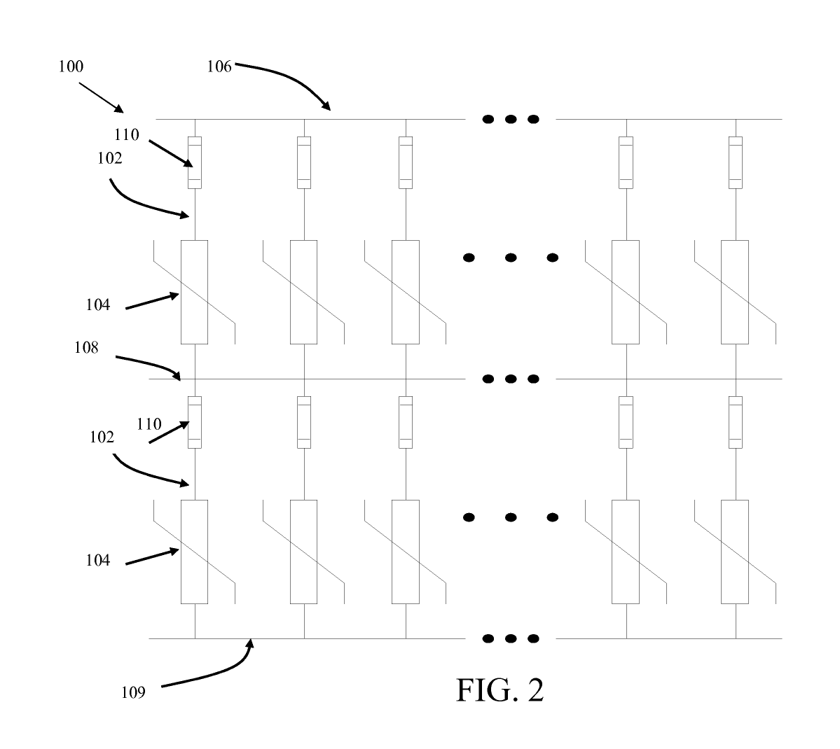

As shown in FIG. 1, each MOV column 102 is positioned between buses 106, 108. For example, each MOV column 102 has a first end connected to a first bus 106, and a second end connected to a second bus 108. It is also understood that while FIG. 1 shows two buses 106, 108 and MOV columns 102 between those buses 106, 108, any number of buses can be used, and MOV columns 102 can be connected in series as well as in parallel. For example, as shown in FIG. 2, a third bus 109 can be included, and MOV columns 102 can be connected in series as well as in parallel.

System 100 further includes at least one fuse 110 positioned on an MOV column 102. For example, at least one fuse 110 can be positioned in series with an MOV 104, between MOV 104 and bus 106, and/or between MOV 104 and bus 108. In one embodiment, each MOV column 102 includes a fuse 110, but it is understood that any number of fuses 110 can be used. For example, one fuse 110 can be connected to a plurality of MOV columns 102. Also, fuses 110 shown in FIGS. 1-4 are external fuses 110, in that they are not integrated with MOVs 104, but it is understood that internal fuses can also be used, i.e., fuses that are inside or integrated with MOVs 104.

Fuse 110 can comprise any type of fuse that is configured to isolate MOV column 102 when activated, for example, a current-limiting fuse. Fuse 110 is configured to isolate the MOV column 102 that it is connected to, in the case that fuse 110 is activated. In this way, if a current passing through MOV column 102 exceeds an activation limit of fuse 110, fuse 110 will activate by creating an open circuit and therefore current will not flow through fuse 110 and MOV column 102.

It is also understood that fuse 110 will also be activated, i.e., break the current, in the case that a MOV 104 connected to fuse 110 takes a current beyond a specified limit for MOV 104. In other words, a surge through MOV 104 of a current higher than the voltage limit of MOV 104 will also activate fuse 110 and will prevent current from flowing through MOV column 102.

In operation, when a MOV column 102 conducts more than its rated current, and more than its “fair share” of current, this excessive conduction can lead to column failure. MOV columns typically fail as a short-circuit. However, embodiments of this invention include a current-limiting fuse 110 that first limits, and then interrupts, the short-circuit current of a failed MOV column 102. In some cases fuse 110 can limit, and then interrupt, the current that exceeds the MOV current rating, and in so doing may also prevent column failure.

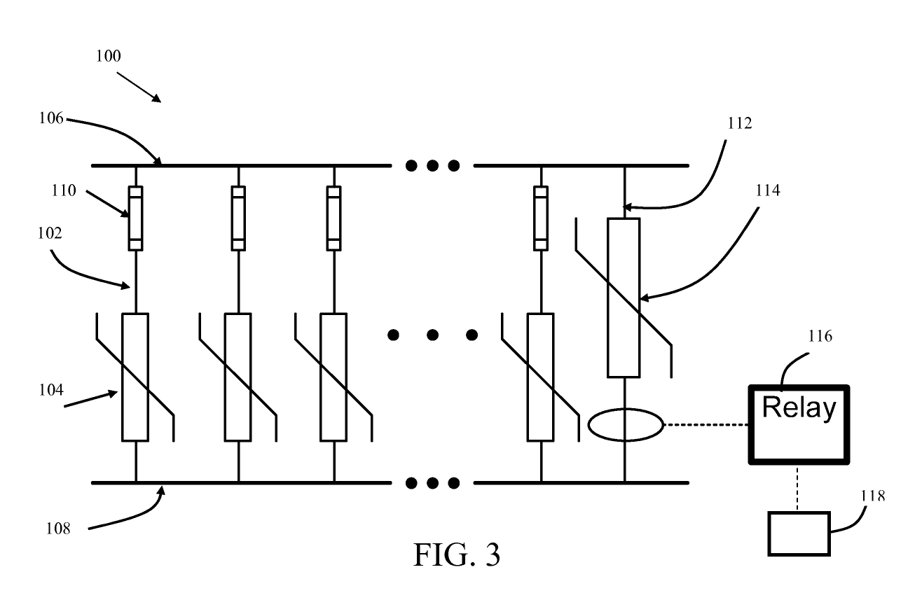

Turning to FIG. 3, in another embodiment, system 100 further includes a high voltage MOV column 112, including a high voltage MOV 114, connected in parallel with MOV columns 102. In the embodiment shown in FIG. 3, high voltage MOV column 112 is connected at an end of the plurality of MOV columns 102. High voltage MOV 114 can be any MOV capable of conducting at a higher voltage than any of the MOVs 104 included in MOV columns 102, and will typically not conduct a significant amount of current at voltage levels that are limited by the operation of MOV columns 102. As shown in FIG. 3, a relay 116 can also be connected in series with the high voltage MOV 114 in high voltage MOV column 112. Relay 116 can be configured to activate in the case that high voltage MOV 114 conducts current, for example, relay 116 can activate by triggering a switch 118 as discussed herein.

Because high voltage MOV 114 will only conduct current if voltage gets above its reference voltage, and MOV 114 will not conduct if a pre-set, minimum, number of MOV columns 102 are connected and effectively limit voltage to a value below the reference voltage of MOV 114, MOV 114 and relay 116 can act as an indicator when all (or a significant number) of fuses 110 have been activated. Relay 116 can be connected to a switch 118 that could switch off current through system 100, or alternately to close a switch to bypass system 100 by electrically connecting bus 106 to bus 108 through a bypass switch, and by doing so collapsing the voltage between the two 106, 108 buses to zero, in the case that relay 116 is activated.

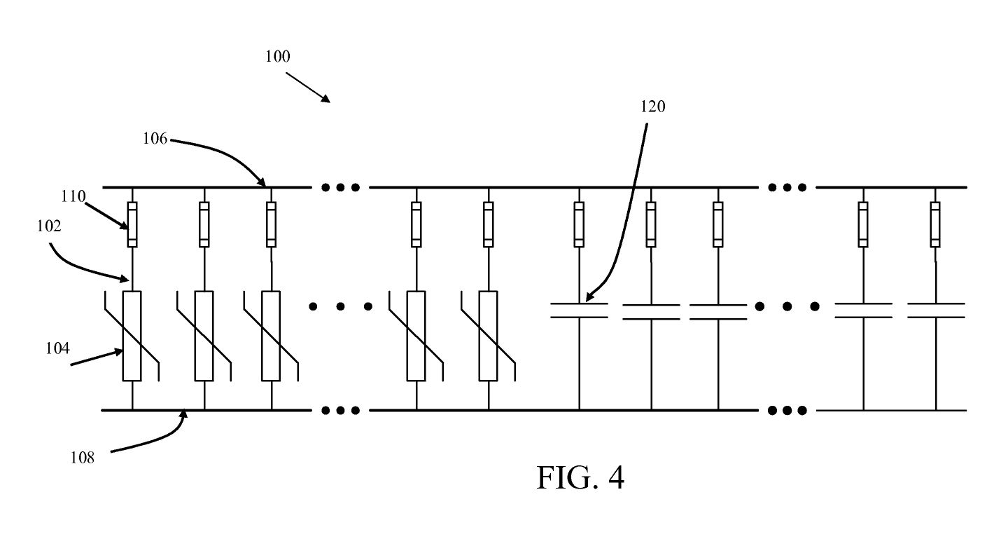

Turning to FIG. 4, one embodiment of system 100 in use is shown. As shown in FIG. 4, system 100 is connected to at least one capacitor 120, each capacitor 120 in a column connected in parallel with the plurality of MOV columns. In this way, system 100 acts as a surge protection system for capacitor(s) 120. As shown in FIG. 4, each capacitor 120 can be connected in series with a fuse 110. In this embodiment, the parallel MOV columns 102 also limit the recovery voltage of an operating fuse 110 to prevent fuse 110 from re-striking Current limiting fuses 110, when interrupting high-frequency current from a high-energy source such as voltage stored in a parallel capacitance, isolate the current by creating a high-magnitude “back voltage” that can compromise dielectric systems nearby. The MOV columns 102 connected in close proximity to capacitor 120 in this embodiment will limit that voltage and mitigate both the chance of fuse-restrike, and also the negative effects of the back voltage from fuse operation.

Embodiments of the invention disclosed herein use current limiting fuses to quickly isolate units that fail due to unequal current sharing, which can produce, over time, an assembly of parallel columns where the lower-voltage units that conduct more than their “fair share” are removed from the circuit by fuse operation, over time leaving an assembly of parallel columns that share current better than at initial assembly. In contrast to prior art methods, embodiments of this invention allow the application of off-the-shelf arresters and fuses, and results in an efficient assembly of parallel columns without requiring conventional current share testing. While external fuses have been used in other applications, e.g., in capacitor applications to isolate failed capacitors, external fuses have not been used in conjunction with MOV columns as discussed herein. Specifically, the fused MOV columns disclosed herein use fuses as a substitute for current sharing, and as a substitute for the post-failure pressure relief and arc control functionality of a conventional MOV design.

Embodiments of the invention disclosed herein use current limiting fuses to quickly isolate units that fail due to unequal current sharing or any other cause of MOV failure. The ensuing short-circuit currents caused by this failure can, if not limited and interrupted by the current limiting fuse, lead to a rise in local pressures that can lead to explosions if not relieved and/or a power arc that is difficult to control and can lead to collateral damage of surrounding equipment from either the arc touching the equipment or the radiated heat from the arc dissipating energy into that equipment. In contrast to prior art methods, embodiments of this invention allow the application of current limiting fuses 110 in lieu of pressure relief and/or arc control devices for the MOV columns 102, and allow for minimized pressure relief and arc control testing, as long as fuses 110 have passed testing to prove they are capable of limiting and quickly interrupting the short-circuit current through the failed MOV columns 102 before pressure buildup occurs and/or the arc gets out of control.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a plurality of metal oxide varistors (MOVs) columns connected in parallel; and
at least one fuse connected to at least one MOV column, the at least one fuse configured to isolate the MOV column in the case that the at least one fuse is activated.

2. The system of claim 1, wherein each MOV column has a first end connected to a first bus, and a second end connected to a second bus.

3. The system of claim 2, wherein the at least one fuse is positioned between an MOV and the first bus.

4. The system of claim 2, further comprising a third bus, and wherein at least two of the MOV columns are connected in series.

5. The system of claim 1, wherein the at least one fuse comprises a plurality of fuses, and wherein each fuse is connected to an MOV column.

6. The system of claim 1, wherein the MOV column will be isolated also in the case that the MOV column takes a current beyond a specific limit for the MOV.

7. The system of claim 1, wherein the at least one fuse is connected in series with an MOV in the MOV column.

8. The system of claim 1, wherein the at least one fuse comprises a current-limiting fuse.

9. The system of claim 1, further comprising a high-voltage MOV column connected in parallel with the plurality of MOV columns, the high-voltage MOV column connected at an end of the plurality of MOV columns.

10. The system of claim 9, further comprising a relay connected in series with a high-voltage MOV in the high-voltage MOV column, the relay configured to activate in the case that the high-voltage MOV conducts electricity.

11. The system of claim 9, wherein the high voltage MOV column includes a high-voltage MOV configured to activate at a higher voltage than the MOVs included in the plurality of MOV columns.

12. The system of claim 1, wherein one fuse is connected to more than one of the plurality of MOV columns.

13. The system of claim 1, further comprising at least one capacitor connected in parallel with the plurality of MOV columns.

14. A system comprising:
a plurality of metal oxide varistors (MOVs) columns connected in parallel;
at least one fuse connected to at least one MOV column, the at least one fuse configured to isolate the MOV column in the case that the at least one fuse is activated; and
at least one capacitor connected in parallel with the plurality of MOV columns.

15. The system of claim 14, wherein each MOV column has a first end connected to a first bus, and a second end connected to a second bus, and wherein the at least one fuse is positioned between an MOV and the first bus.

16. The system of claim 15, further comprising a third bus, and wherein at least two of the MOV columns are connected in series.

17. The system of claim 14, wherein the at least one fuse comprises a plurality of fuses, and wherein each fuse is connected to an MOV column.

18. The system of claim 14, wherein the at least one fuse is connected in series with an MOV in the MOV column.

19. The system of claim 14, further comprising a high-voltage MOV column connected in parallel with the plurality of MOV columns, wherein the high-voltage MOV column includes a high-voltage MOV configured to activate at a higher voltage than the MOVs included in the plurality of MOV columns, and wherein the high-voltage MOV column is connected at an end of the plurality of MOV columns.

20. The system of claim 19, further comprising a relay connected in series with a high-voltage MOV in the high-voltage MOV column, the relay configured to activate in the case that the high-voltage MOV conducts electricity.
